(19) United States
(12) Patent Application Publication
(10) Pub. No.: US 2004/0224685 A1
(43) Pub. Date: Nov. 11, 2004

(54) Communication device with a simplified user interface

(76) Inventors: Todd Hertzberg, Denedin, FL (US); Lone Tram Sorensen, Roskilde (DK); Henning Lunoe, Koge (DK); Povl Koch, Copenhagen K (DK); Claus Aagaard Pedersen, Frederiksberg (DK); Jens Benner, Copenhagen O (DK); Asger Stoustrup, Copenhagen N (DK); Kevin McCarthy, Vaerloese (DK); Pierre Middleton, Faber Crest (SG); Mikko Viitanen, Espoo (FI); Anand Narang, Hellerup (DK); Panu Korhonen, Helsinki (FI); Juha Pinomaa, Kaunianinen (FI); Marianne Thomsen, Frederiksberg C (DK); Christian Kraft, Hvidovre (DK); Harri Wikberg, Helsinki (FI)

Correspondence Address: PERMAN & GREEN, 425 POST ROAD, FAIRFIELD, CT, 06824, US

(21) Appl. No.: 10/435,284

(22) Filed: May 9, 2003

(51) Int. Cl. H04Q 7/20

(52) U.S. Cl. 455/434; 455/422.1

(57) ABSTRACT

A communication device includes a simplified interface to the user limiting the user to use a keypad, light sources and audio capability to operate the communication device. Having the light sources and a limited number of keys on the keypad to co-operate in the operation of the communication device, the user is still able to perform the basic functions of a communication device.

### BACKGROUND OF THE INVENTION

1. Field of the Invention

The present invention relates to a communication device to be used for communication between people, where the communication device has a simplified interface which may be limited to a keypad, light sources and audio capabilities.

2. Brief Description of Related Developments

Communication devices or mobile phones are widely known in different shapes and forms, and include different kinds of interfaces and functionalities. Known communication devices are in many aspects quite complicated for the user to operate since they require a level of understanding and abilities. New users, user lacking understanding, or those not having technical abilities are in many cases shut out from using the communication devices since they have a complicated user interface. E.g. people that not are able to read for some reason will have difficulties reading the display and what is shown on the display.

Furthermore some users may be interested in providing communication devices to other persons. The reason for this could be, for example, maintaining communication with an elderly parent or a child that is starting to be out on his own, or in the case of an employee that an employer wants to contact or be contacted by. There could of course be many other reasons for a user to provide another person with a communication device, but one common aspect may be that the user having the interest may also be the main-subscriber or the person financially responsible for the communication devices that they are providing to others. For purposes of this invention, this person will be referred to as the responsible person. The responsible person therefore may have an interest in controlling or limiting the use of the communication devices provided to others, while enabling the others to get in contact with him/her in a simple way.

### SUMMARY OF THE INVENTION

The claimed invention aims to provide a communication device with a user interface that is generally simple and operable. It further aims to provide a communication device that enables a responsible person to supply others with a communication device and still have control over the communication device and the costs incurred by the use of it.

It is a feature of the present invention to provide a communication device having a user interface enabling operation of the communication device by an inexperienced user, or a user lacking knowledge or abilities to operate previously known communication devices.

According to one embodiment of the claimed invention this feature is provided by a communication device having light sources for communicating the state of the communication device to the user.

Another feature of the present invention is to provide a method for operating a communication device without using a conventional display in a manner that can give feedback to a user of the communication device.

According to another embodiment of the claimed invention this feature is provided by a method for operating a user interface of a communication device having a set of light sources, where the light sources enable at least the following operations on the communication device:

display phone status

indicate of condition of battery status and network strength

indicate of location in menu structure

indicate of location in a phonebook associated to the communication device

call a party or number in a phonebook associated to the communication device

indicate a missed call from a party or person

indicate the identity of a person calling to the communication device.

### BRIEF DESCRIPTION OF THE DRAWING

The invention will be explained more fully below, by way of example, in connection with preferred embodiments and with reference to the drawing, in which:

FIGS. 1-5 show different embodiments of a communication device according to the claimed invention;

FIG. 6 shows a preferred embodiment of a communication device provided with a keypad and light sources according to the claimed invention;

FIG. 7 schematically shows the essential parts of a communication device for communication with a cellular network;

FIG. 8 shows an example of how colour coding can be configured; and

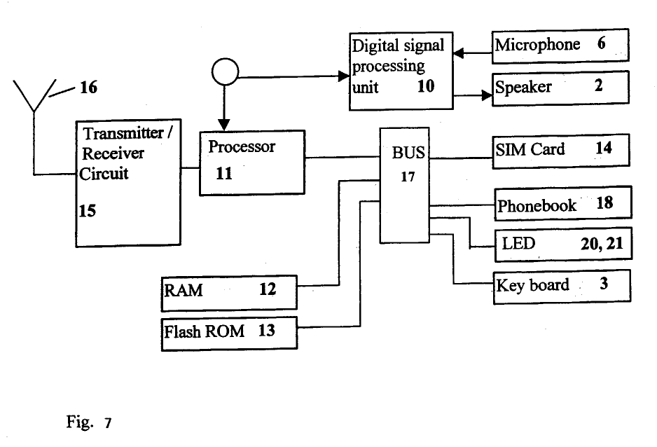

FIG. 9 shows a sequence of colour coding matching a phone number.

### DETAILED DESCRIPTION OF THE INVENTION

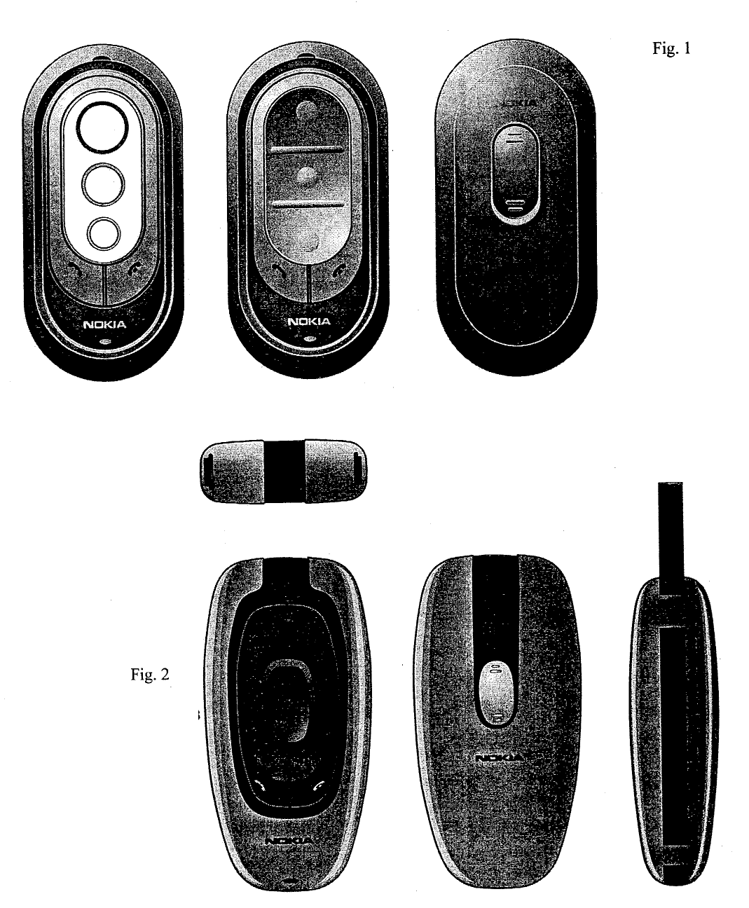

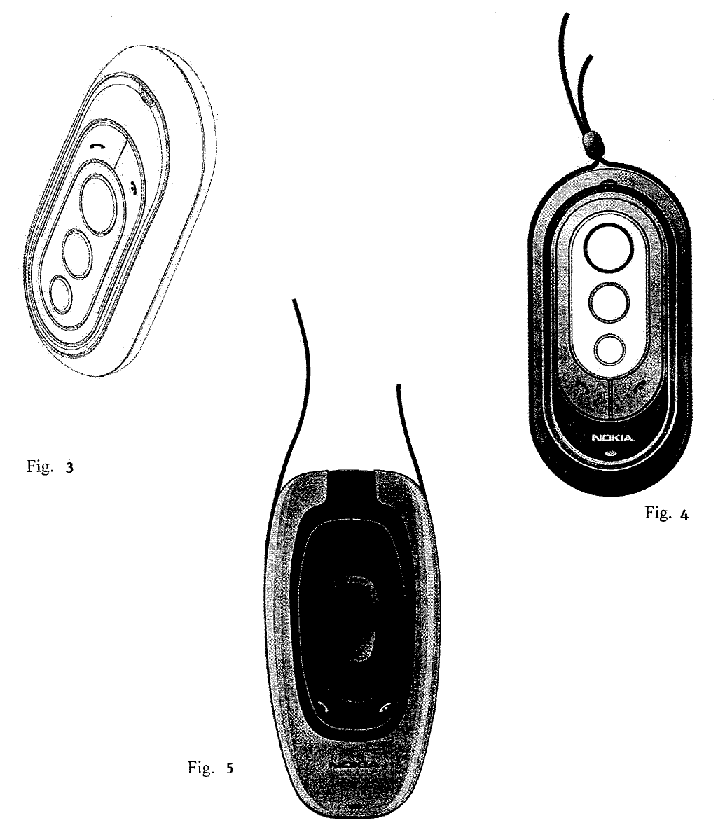

According to a first aspect, the invention will be described with reference to a communication device. FIGS. 1-5 show different embodiments of the communication device of the present invention. As will be seen, the communication device in FIG. 6 is provided with a user interface having a speaker 2 (only openings are shown), a keypad 3, a battery 4, a set of discrete light sources, in this embodiment shown as LED's 5, a buzzer 19 and a microphone 6 (only openings are shown).

The keypad 3 has a first group of keys 7 designated as user defined keys, by means of which the user can make telephone calls, send a text message (SMS), etc. The user-defined keys 7 are provided with a different colour, size or otherwise unique appearance to differentiate between or among the user-defined keys.

The keypad 3 additionally comprises two soft keys 8 and a navigation-key 9. The soft keys 8 are used for establishing a call or a conference call, terminating a call, rejecting an incoming call, turning the communication device on or off, or selecting items or functionalities in a navigation menu associated with the user interface.

The navigation-key 9 is an up/down key and is placed centrally on the front surface of the phone. A user may be able to control this key with his thumb. This may be an optimum site to place an input key requiring precise motor movements. Many experienced phone users may be used to one-hand handling or operations. The phone may be placed in the hand between the fingertips and the palm of the hand, freeing the thumb for inputting information.

The microphone 6 and the speaker 2 can be located on the opposite side of the communication device so that the keypad 3 is located on one side of the communication and the microphone 6 and speaker 2 on the other side.

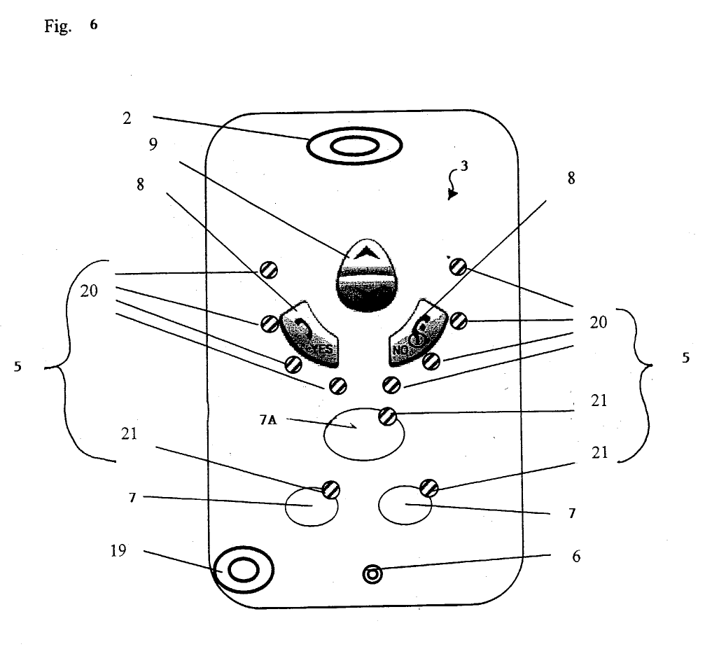

This means that the user in most cases will place the communication device with the keypad 3 turned away from the user when calling another party. The buzzer 19 may be used for ringing tones, error beeps etc. FIG. 7 schematically shows parts of one embodiment of the communication device in accordance with the present invention. The microphone 6 records the user's speech, and the analogue signals formed thereby are converted from analog to digital form in an A/D converter (not shown) before the speech is encoded in an audio part 10 which includes a digital signal processor. The encoded speech signal is transferred to a processor 11 which may be a physical layer processor and which e.g. supports communication device software. The processor 11 also forms the interface to the peripheral terminals of the apparatus, including RAM and ROM memories 12 and 13, a SIM card 14, a set of discrete light sources, shown in this embodiment as LED's 20/21 and the keypad 3 (FIG. 6) as well as a data terminal, power supply, etc. (not shown). The processor 11 controls the communication with the network via the transmitter/receiver circuit 15 and an antenna 16. The audio part 10 speech-decodes the signal, which is transferred from the processor 11 to the speaker 2 via a D/A converter (not shown).

The processor 11 is connected via a bus 17 or other electrical connecting means to a RAM memory 12 and a Flash ROM memory 13, a SIM card 14, the LED's 20/21 and the keypad 3 (as well as a data terminal, power supply, etc., not shown). Furthermore a phonebook 18 is connected to the processor 11 via the bus 17. The phonebook 18 may be stored on the SIM card 14, and/or in the Flash ROM memory 12.

One embodiment of the communication device of the invention is adapted for use in connection with a GSM network, but, of course, the invention may also be applied in connection with other communication terminal networks, for example, cellular networks, various forms of cordless communication terminal systems, or dual band communication terminals accessing sets of these systems/networks.

The communication device may initially be in an idle mode, which means that the communication terminal may be turned on and ready to be used for any possible operation. The communication device may be turned on or off by a long-press of one of the soft-keys 8. When turned on, the communication device may flash one or more LED's 20 to indicate that the communication device in switched on. This flashing may be unique so as not be confused with other indications.

As described above in connection with FIG. 6, the communication device is provided with a number of light sources or LED's 5. The LED's 5 are arranged to support the operation of the communication device. In the preferred embodiment shown in FIG. 6 are a first group of LED's 20 which may be arranged like a half circle in relation to the two soft keys 8 and the navigation-key 9, and a second group of LED's 21 which may be arranged in relation to the user-defined keys 7. Depending of the status of the communication device, the different groups of LED's 20 and 21 may indicate different things. The first groups of LED's 20 that are disposed around the two soft keys 8 and the navigation-key 9 may indicate the battery charging level and the strength of the network signal when the communication device is in the ready to operate mode. The left four LED's 20 may indicate the strength of the network signal, where the weakest network signal is indicated by only one LED 20 flashing, the LED's 20 most to the right of the four left LED's 20 or the bottom of the half-circle, and the strongest network signal is indicated by having the four left LED's 20 flashing. Likewise, the four right LED's 20 may be used to indicate the battery charging level, where the lowest battery charging level signal is indicated by only one LED 20 flashing, the LED 20 most to the left of the four right LED's 20 or the bottom of the half-circle, and the highest battery charging level is indicated by the four right LED's 20 flashing. The LED's 5 are associated with the user interface to indicate different states of the communication device.

Since the embodiment shown in FIG. 6 does not include a conventional display to show the user the operation, the combination of the LED's 5 and voice playback capability may be used to guide the user in the operation of the communication device. A first example of this is to scroll the phonebook of the communication device, where the user presses the left soft-key 8 to enter the phonebook. This will flash the LED 20 furthest to the left and the number/person entry allocated to that position will be played on speaker to the user. By using the navigation-key 9 the user will be able to scroll to other positions in the phonebook, where another LED's 20 will be flashing and voice-playback will indicate the number/person entry allocated to the specific position. In one embodiment, the entry positions available in the phonebook may be limited by the number of LED's 20. In other embodiments, there may be more or less LED's 20 in the communication device and the number of available speed dial numbers may correspond to the number of LED's 20. One or more of the user defined keys 7 may be designated a favourite key 7A and may also be used for allocating phone numbers from the phonebook. A favourite key 7A may be defined so that a simple press on the corresponding key will initiate the set-up of the phone call to a phone having the number allocated to that key 7. Typically the number allocated to the favourite key 7 may be supplied by the responsible person of the communication device whereas the user can more freely decide other phone numbers. One way to allocate the numbers is simply locate the numbers on the first eleven positions on the SIM card 14 associated with the communication device. Other ways of allocating numbers will be described later. There is a timeout in this mode where the LED's 20 start to flash and the speed dial selection is switched off to save the battery.

When making a phone call using any of the favourite keys 7A, the LED's 21 placed in relation to the corresponding favourite key may flash. Likewise the LED's 21 will flash when receiving calls (e.g. fast flashing) from a favourite key number, and the LED's 21 may also be used when the user has a missed call from one of the favourite numbers (slow flashing). The favourite key 7A can further be used for sending a short message that indicates to another person that the user wants to be called up, a “Call Me” message. The communication device has the ability to easily send “Call Me” messages to numbers associated to the favourite key 7A. To send a “Call Me” message to one of the favourites numbers, the user simply long-presses the corresponding favourite key 7A. In one embodiment, it may only be possible to send “Call Me” messages to the numbers associated with favourite keys 7A and not to any number in the phonebook or other phone numbers. The “Call Me” message is typically a pre-defined short message that indicates that the user want to be called up by the person associated to the favourite key 7A. The favourite keys 7A may be divided into kinds, for example, a primary speed-dial key (‘Master’ key) and secondary speed-dial keys. They may differ in their physical appearance, where a primary speed-dial key typically may be bigger than two secondary speed-dial keys. They can of course differ in other ways as well, e.g. colour or shape. Another functionality is that the user can assign a ‘Voice tag’ for each of the speed dial or favourite keys 7A. This could be used to give voice playback to the user when he/she is calling the speed dial numbers, i.e. when the user then presses any of the speed dial keys 7, the user will immediately hear in the earpiece/speaker 2 the recorded ‘name’ for the person or other indication of the number being called. Another way of setting up calls can be using voice recognition, where the user have entered as voice tag for each speed dial key and possibly for each other number in the phonebook. The voice calling can be initiated by pressing the left soft-key 8 as the user normally does when he want to use a name from the phonebook, where after the user says the name or other word associated to the number and the communication device sets up the call.

An ongoing call is indicated by e.g. flashing all LED's 20 and 21 every second. The speaker/earpiece 2 volume can be adjusted during the call with the navigation-key 9. Scrolling down decreases the volume and scrolling up increases the volume. The present volume level will be indicated with flashing LED's 20, where a single flashing LED 20 indicates a low volume level and where eight flashing LED's 20 indicates that the maximum volume level is selected. The volume level is shown for a few seconds with the LED's 20 before a timer turns them off. The user presses the right soft-key 8 to end an active/ongoing call.

If the user presses the navigation-key 9 from idle mode the menu structure will be available, the currently active/highlighted menu in the structure is indicated by flashing one of the LED's 20, typically the most left or right LED 20, and the voice play-back will prompt the name of the menu. To select a menu, the user simply presses the left soft-key 8. Whenever the user presses the navigation-key 9, the communication device will ‘prompt’ the corresponding menu and the corresponding LED 20 will be updated. The method of also using the LED's 20 for indicating the current menu can allow users who have ‘learned’ the menu structure to operate basic functions even without voice prompts. Sub-menus may also contain spoken ‘choices’, which the user then can scroll and select; just like the ‘main menu. To exit the menu structure, the user can press the right soft-key 8.

In the shown embodiment the communication device is provided with eight LED's 20, which limit the number of menus on each level. The number of LED's 20 can of course be different within the scope of the invention and not limited to just eight LED's 20. The voice/speech prompts are used to give various feedback to the end user, e.g. when scrolling the menu system supported in the communication device. The voice prompts are pre-recorded and are outputted through the earpiece/speaker 2.

In the menu structure there typically can be the following different menus and sub-menus:

Keypad Lock

Ringing volume

Change ringing tone

Show Battery and signal level status

Read out operator name

Indicate if Roaming

Changing Language (default language will be based on SIM nationality)

Calling Line Identification dependent ringing tones set-up

Reception of new ringing tones OTA via smart message+assign

Recordable ringing tone

Simple alarm feature/count down: Maybe with pre-defined ‘delay’ which can be ‘multiplied’

To-do list based on multiple voice memos

Time read aloud/tower clock beeps (Requires NITS or manual time entry)

Date read aloud

Voice skins; let phone talk with different voices

Restore factory settings.

Presence indication for Favourites

Erase all SMS and/or SMS auto-erase on/off

The content of the menus can of course be different, likewise can the number of menus be different within the scope of the invention.

To avoid any undesired call set-up when the communication device is turned-on and in an idle state the keypad 3 can be locked or made non-responsive to unintentional key-press by the user. Keypad can be activated and de-activated by pressing two keys at the same time OR by pressing two keys after each other, e.g. pressing the left soft-key 8 and another key. The indication of keypad locked status of the communication device could be indicated by flashing ALL LED's when any key is pressed (except for left soft-key 8). If it is chosen to unlock the keypad 3 with a key combination (e.g. left soft-key 8 and favourite key/primary speed-dial key 7A), the user could get help with LED's when unlocking keys: When left soft-key 8 is pressed, the LED 21 behind the primary speed-dial key will be flashing to indicate, which key to press next. The key-lock is also provided with a time-out that requires that the two key-presses need to be done within a certain time or the timer will be reset.

The user can answer any incoming call by pressing the left soft-key 8 or if the incoming call is from one of the favourites, the call can also be answered by pressing the corresponding favourites key 7A, e.g. the Master-key. An incoming call can be answered even when keypad is locked. An incoming call is indicated by playing ringing tone and by flashing the LED's 20 and 21 by a flashing pattern or just by flashing all the LED's 20 and 21. There will typically be a distinct tone for each of the 3 main speed dial number plus a ‘generic’ one for all other numbers in the phonebook. The flashing of the LED's 20 and 21 assures that an incoming call is indicated even though the communication device has been set to silent. In case a call is received from one of the favourites the corresponding LED 21 for that favourite is also lit or flashing. Pressing the right soft-key 8 can reject any incoming call. The ringing volume can be adjusted during incoming calls by simply press the navigation-key 9 up/down during an incoming call. Pressing down decreases the ringing volume level and pressing up increases the ringing volume level. The LED's 20 indicates the ringing volume level. No flashing LED's 20 means silent and eight flashing LED's 20 means maximum ringing volume level. Whenever adjusting the ringing volume will be stored and used for all future calls or until ringing volume is adjusted again. As said the LED's 20 will show the current ringing level and a timer turn offs the LED's 20 after a certain timeout. The user can also adjust the ringing volume via the (voice) menu system.

A waiting call is indicated with a ‘beep’ in the speaker/earpiece 2. The LED's 20 and 21 can also be used to indicate a waiting call. To answer a waiting call, the user can answer/swap the call by pressing the left soft-key 8; in this case two calls will then be active at the same time. The User can swap between the calls with the left soft-key 8 and end the active call with the right soft-key 8. When a call is waiting the user can also choose to first press the right soft-key 8; this will end the current call and the waiting call will be ringing as a normal call and can be answered with left soft-key 8 with the speed dial keys 7 if the calling party is anyone of the speed dial parties. Finally, the user can of course ignore the waiting call. The missed call will be indicated as a ‘normal’ missed call to the user.

The assignment of the numbers to the favourite keys 7A can be done in several ways. As mentioned above can it be done with auto-assigning the first three entries from SIM card 14(and/or the three names from SIM Called with the names ‘1’, ‘2’ and ‘3’); this allows setting up the numbers in a normal phone, or by a dealer or an operator. If FDN (Fixed Dialling Number) is active, the first 3 FDN numbers can be used. Manual input by; e.g. very-long-pressing a favourite key 7A and then using any of the “manual” (voice or keypad driven) number input methods. Another method is the “Over-The-Air”, OTA method using a special smart message/business card format that is send to the communication device and accepted by the user upon arrival. The number sent by OTA can be spoken to the user by voice playback or perhaps using the LED's 20 and 21. Yet another method is Call Line identification (CLI), where the user assign the last received number to any of the favourites, e.g. by very-long-pressing the corresponding key 7.

A missed call from a favourite/speed dial is indicated by flashing the LED 21 for the corresponding favourite key 7A. This flashing will continue until the user has called the person associated to that speed dial key 7 or until the communication device has been switched off and then on. The user may be able to see whether there are 2 or more missed calls from the person. The user may also see if there are missed calls from any of other speed dial numbers in the phonebook since the corresponding LED 20 will flash. Missed calls from persons other than the ones stored on the Speed dial keys (favourites or the phonebook) can be indicated with LED's 20 or/and21, e.g. a certain pattern is run and user can ‘hear’ the number spoken from the menu. Possibly this missed call may be used or added to the phonebook and may be used for speed dial. Another possibility is to have an option to get ‘voice prompts’ for all numbers that are missed calls or having a ‘DTMF tone playing’ option for all missed calls and using this method together with a fixed line phone, the user can ‘automatically’ dial the numbers back. The user can use the last received or missed call by pressing the right soft-key 8 twice. It might also be possible to scroll down in a menu or sub-menu to find the last received or missed call and to call back to the person associated with that number.

Using the communication device for calling any number over and above any of the eleven speed dial options, corresponding to the number of favourite keys and LED's 20, is not obvious since the communication device does not have any numerical keys that can be used for input of the phone number or other numbers. The other numbers that need to be entered can e.g. be a pin code that are used according to the GSM specification to activate the SIM card 13. Below is shown a couple of methods to enter numbers on a communication device not having numerical keys.

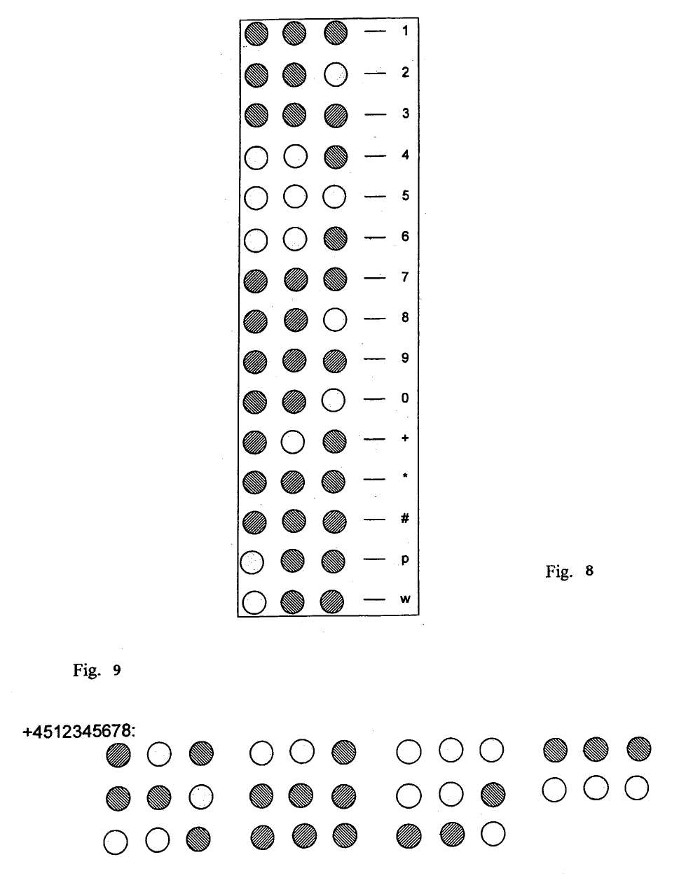

The number input methods have in common that a menu or mode need to be activated, which is done as shown above with pressing the navigation-key 9 and using the left soft-key 8 to select the desired keypad digit input mode or menu after being prompt by voice play-back. A first method utilises the scroll-keys to scroll digits one by one; whenever the user scrolls down or up, the next/previous digit is ‘spoken’ as ‘voice play-back’. The user can selects a digit by pressing the left soft-key 8. To dial the number, the user presses the left soft-key 8 once more after entering the last digit. The second method is similar to the first method but using LED's to indicate, which digit that is highlighted. The eight LED's 20 can indicate the numbers 1to 8 from left to right and having the LED's 21 allocated to the secondary speed dial keys to indicate 0 and 9. Other solutions are of course possible. The third method is based on mapping digit groups to each of the keys (including the navigation-key 9 and the favourites keys 7A); e.g. 1-3 to scroll up, 4-6 to scroll down, 7-9 to first favourites keys, etc. The user can then ‘guess’ what is being typed in without voice playback. An option with voice playback of the entire number could of course be a possible option. The fourth method is based on ‘colour combinations’, in other words based on pressing two of the (coloured) favourite keys 7A consecutively. The favourite keys 7A need in this method to be coloured differently This method further requires a small leaflet, which explains what key different combinations will give, e.g.: Yellow-Yellow gives ‘1’, Blue-Blue gives ‘2’, Yellow-Blue for ‘3’ etc. See FIGS. 9 and 10 for an example of colour coding and a simple number combination using the colour codes. This method could even be extended (with 3 key-presses) to also cover (Latin) text input. A fifth method can be voice input, where the user say the desired numbers in a sequence and confirms the number with the left soft-key 8.

In summary can the left soft-key 8 be used to answer calls, call one of the phonebook speed dials, selecting (voice) menus (Yes) and from idle mode is the left soft-key 8 used to enter selection of phonebook speed dials. The right soft-key 8 is used to power on/off the communication device, used to reject incoming calls, used to ‘exit’ menus and e.g. other ‘modes’. The navigation-key 9 is used to control volume, adjusting ringing tone volume, and for scrolling voice menus and other ‘lists’ (e.g. the phonebook speed dials). The primary speed dial key links to the most used speed dial number. Short-press to dial the number associated to the speed dial key. Long-press to send ‘Call me’ message to the speed dial number. The secondary speed dials keys (2) links to contains two other speed dial number and are used in same way as the primary speed dial key. The eight LED's 20 can be maybe divided into two groups with each 4 LED's 20. These LED's 20 are used for multiple purposes, e.g. for indicating progress (‘running’), for indicating ‘errors’ and status (flashing in various ways), as ‘scroll bars’ in the voice menu and for indicating levels (battery/signal).

Please note that the LED's 20 and 21 can be flashing in different ways to show different things to the user. This can be done by using different colours and flashing patterns. The examples given in the application are only examples and can of course be changed within the scope of the invention.

The invention is not limited to the above-described examples or to the drawings showing examples of an embodiment, but can be varied within the scope of the appended claims.

What is claimed is:

1. A communication device provided with a set of light sources to enable a user to interface with and operate a user interface of the communication device, wherein the communication device only displays the user interface through the light sources.

2. The device of claim 1, wherein the set of light sources is a set of discrete light sources adapted to flash in a pattern to indicate the status of the device.

3. The device of claim 1, wherein the set of light sources is a set of discrete light sources adapted to flash in a pattern to indicate a battery charging level.

4. The device of claim 1, wherein the set of light sources is a set of discrete light sources adapted to flash in a pattern to indicate a network signal strength.

5. The device of claim 1, wherein individual ones of the set of light sources are adapted to flash to indicate a position in a communications device phone book.

6. The device of claim 1, wherein individual ones of the set of light sources are adapted to flash to indicate a position in a menu of communications device functions.

7. The device of claim 1, wherein the set of light sources is a set of discrete light sources adapted to flash in a pattern to indicate an incoming call.

8. The device of claim 1, wherein the set of light sources is a set of discrete light sources adapted to flash in a pattern to indicate an ongoing call.

9. The device of claim 1, wherein the set of light sources is a set of discrete light sources adapted to flash in a pattern to indicate a missed call.

10. The device of claim 1, wherein the set of light sources is a set of discrete light sources adapted to flash in a pattern to indicate a volume level of the communications device.

11. A communication device provided with a set of discrete light sources to enable a user to interface with and operate a user interface of the communication device in combination with a keypad also provided on the combination device, wherein the communication device only displays the user interface through the discrete light sources.

12. The device of claim 11, wherein the keypad has one or more keys, and wherein individual ones of the set of discrete light sources are associated with the one or more keys.

13. The device of claim 12, wherein the individual ones of the set of discrete light sources are adapted to flash upon a pressing of the associated one or more keys.

14. The device of claim 11, wherein the set of discrete light sources is adapted to flash in a pattern to indicate the status of the device.

15. The device of claim 11, wherein the set of discrete light sources is adapted to flash in a pattern to indicate a battery charging level.

16. The device of claim 11, wherein the set of discrete light sources is adapted to flash in a pattern to indicate a network signal strength.

17. The device of claim 11, wherein individual ones of the set of discrete light sources are adapted to flash to indicate a position in a communications device phone book.

18. The device of claim 11, wherein individual ones of the set of discrete light sources are adapted to flash to indicate a position in a menu of communications device functions.

19. The device of claim 11, wherein the set of discrete light sources is adapted to flash in a pattern to indicate an incoming call.

20. The device of claim 11, wherein the set of discrete light sources is adapted to flash in a pattern to indicate an ongoing call.

21. The device of claim 11, wherein the set of discrete light sources is adapted to flash in a pattern to indicate a missed call.

22. The device of claim 11, wherein the set of discrete light sources is adapted to flash in a pattern to indicate a volume level of the communications device.

23. A method for operating a user interface of a communication device provided with a set of light sources where the light sources enable at least the following steps of operation:
display phone status
indicate a condition of battery status and network strength
indicate a location in a menu structure
indicate a location in a phonebook associated to the communication device
call a party or number in a phonebook associated to the communication device
indicate a missed call from a party or person
indicate an identity of a person calling to the communication device.

24. A method of operating a communication device comprising:
providing a user interface having a display comprising a set of discrete light sources; and
flashing the set of discrete light sources in a pattern to indicate the status of the device.

25. The method of claim 24, further comprising flashing the set of discrete light sources in a pattern to indicate a battery charging level.

26. The method of claim 24, further comprising flashing the set of discrete light sources in a pattern to indicate a network signal strength.

27. The method of claim 24, further comprising flashing the set of discrete light sources in a pattern to indicate a position in a communications device phone book.

28. The method of claim 24, further comprising flashing the set of discrete light sources in a pattern to indicate an incoming call.

29. The method of claim 24, further comprising flashing the set of discrete light sources in a pattern to indicate an ongoing call.

30. The method of claim 24, further comprising flashing the set of discrete light sources in a pattern to indicate a missed call.

31. The method of claim 24, further comprising flashing the set of discrete light sources in a pattern to indicate a volume level of the communications device.

32. The method of claim 24, wherein the user interface further comprises a keypad having one or more keys, the method further comprising associating individual ones of the set of discrete light sources with the one or more keys.

33. The method of claim 32, further comprising flashing individual ones of the set of discrete light sources upon a pressing of the associated one or more keys.
